(19) United States
(12) Patent Application Publication
(10) Pub. No.: US 2008/0231005 A1
(43) Pub. Date: Sep. 25, 2008

(54) Wheel chair

(76) Inventors: Ivan P. Clark, Rockwood (CA); Samuel A. Gibney, Barrie (CA)

Correspondence Address: D.W. EGGINS, 18 DOWNSVIEW DRIVE, BARRIE, ON, L4M 4P8, CA

(21) Appl. No.: 11/723,469

(22) Filed: Mar. 20, 2007

(51) Int. Cl. A61G 5/06

(52) U.S. Cl. 280/5.3

(57) ABSTRACT

A curb-climbing vehicle with a pair of front wheels has a lifting device attached to each wheel, which engages the curb edge, and raises the wheel so that it can engage and roll up over the curb. A wheelchair embodiment incorporates user support elements that are adjustably secured to central ‘spine’ elements, enabling the chair structure to be adjusted to the person of the individual user, including possible asymmetric adjustments. The chair running gear includes larger driving wheels, centrally located, and fore and aft independently suspended castoring wheels.

### CROSS-REFERENCE TO RELATED APPLICATIONS

Not Applicable (N/A)

### STATEMENT REGARDING FEDERALLY SPONSORED RESEARCH OR DEVELOPMENT

N/A

### REFERENCE TO A SEQUENCE LISTING, A TABLE, OR A COMPUTER PROGRAM LISTING

N/A

### COMPACT DISC APPENDIX

N/A

### BACKGROUND OF THE INVENTION

1. This invention is directed to an improved wheelchair, and in particular to a wheelchair with castoring front wheels modified to facilitate curb-climbing, and with fully adjustable seating provisions to cater to a wide range of variations in users individual body geometries, and to accommodate to bodily changes that individuals may experience.

2. Existing wheel chairs have very limited capability in climbing curbs, which has led to massive efforts in many societies towards making public buildings “wheel-chair accessible” by way of ramps and beveled curbs.

A major limitation on wheelchair curb-climbing capability is a consequence of the general adoption of small diameter castoring front wheels. This wheel size limitation arises from a number of factors, including the presence of foot-rests located between the two front wheels; the need to restrict the over-all lateral width of the chair, and the desirability of providing a high degree of castoring rotation capability of each wheel about its vertical axis of castor. The ability of a wheel to climb a curb requires the rotational centre of the wheel to be positioned above the level of the curb, so that the current small diameter front wheels can only climb low curbs, curbs whose edges do not stand above the wheel centre of rotation.

A further problem presented by castoring wheels, when being forced against a curb in an attempt to mount the curb, is a tendency to pivot about its castoring axis, so as to jam ‘flatwise’ against the curb.

Concerning seating provisions, the geometry of current wheelchairs is substantially fixed between opposed side frames, being directed towards an “average” person of the class using the wheelchair. The traditional fixed geometry virtually eliminates any potential for making asymmetrical adjustment, to suit the individual body geometry of the user.

This frequently leads to extreme discomfort and fatigue for a user whose body geometry is not sufficiently ‘average’ to conform to the chair.

### BRIEF SUMMARY OF THE INVENTION

The present invention provides a wheeled vehicle having front wheels of predetermined size, for passage upwardly over an obstacle, the vehicle including elevator means secured to the front castoring wheels of the vehicle and positioned to contact the obstacle before the front wheels make contact with the obstacle; wherein forward motion of the vehicle produces reaction between the elevator means and the obstacle, to raise the front wheels into self-elevating, roll-over relation with the obstacle.

In one embodiment. the present invention provides a wheelchair having elevator means associated with each of the front, castoring wheels, which elevator means, on contacting a curb edge, serves to raise the front wheel until its centre of rolling rotation is above the curb edge, whereby the wheel then makes contact and continue to roll upwardly over the curb.

The elevator means may have a pivotal centre located above the rotational axis of the castor wheel; and it may include a pair of mutually spaced-apart guide ribs, the profiled forward edges of which serve to orient the castoring wheel in stabilized relation substantially normal to the curb.

The present invention thus provides a wheeled vehicle having front wheels of predetermined size, for use in passage upwardly over an obstacle, the vehicle including elevator means secured to the front wheels of the vehicle and positioned to contact an obstacle before the front wheels make contact with the obstacle; wherein forward motion of the vehicle produces reaction between the elevator means and the obstacle, displacing the elevator means downwardly in relation to the wheel, so as to raise the rotational axis of the front wheel above the level of the obstacle, whereby the wheel is enabled to climb upon the obstacle, on the maintenance of that forward motion.

The front wheels of the subject vehicle are each rotatably mounted to a fork, each fork being secured to the vehicle by a substantially vertical castor axle about which the wheel can be self-orienting.

The aforesaid elevator means has at least one contact member for contacting the obstacle, being pivotally attached to the forks at a location positioned above the rotational axis of the front wheel.

The elevator means has a pair of the aforesaid contact members; with a transversely extending bridge member securing the contact members in mutually spaced, load-sharing relation.

The aforesaid contact members each have a substantially arcuately profiled surface to make contact with the obstacle.

The radius of rotation of the elevator means from their point of pivotal attachment to the forks is significantly greater than the radius of the wheel.

The construction of the wheelchair may include a central ‘spine’, to which support components for the user's body are adjustably secured, thereby enabling virtually universal accommodation to the bodily geometry of a user. This accommodation includes independent left and right side adjustment, thereby accommodating to physical asymmetry of the user's person or posture.

Thus, the present invention provides an adjustable chair structure for supporting the person of a user thereon, having a spine portion comprising at least two parts, at least one of which parts has two portions in selective mutually slidable relation to enable elongation of that part; and laterally extensible body support portions secured to the spine portion, to provide a range of adjustment to the chair structure, to accommodate a range of variation in the body geometry of a user.

The structure has three such spine portion parts, comprising a centrally located seat spine portion, a back spine portion secured to a rear end of the seat portion, and a calf spine portion secured to the front end of the seat portion.

Each of the three spine portion parts are longitudinally extensible, and each have the aforesaid laterally extensible body support portions secured to them.

The laterally extensible body support structures include a pair of arm canes, and a pair of back canes and a pair of footrest supports.

The arm support structure includes repositioning provisions whereby the arm canes may be repositioned rearwardly to the extent of enabling the wheelchair to be moved forwardly beneath a computer keyboard, such that the occupant can readily access that keyboard while remaining seated in the wheelchair.

Variations in body dimensional characteristics are accommodated by:

Hip extension, knee extension and ankle extension.

These three extension provisions may be accomplished by pivotal rotational adjustments between adjacent parts that are pivotally connected.

Changes in back width, seat width, and footrest provision can be effected, respectively, by:

moving one or both of the back canes, in or out, relative to the supporting spine portion;

moving one or both arm brackets and canes in or out, relative to the supporting spine portion;

moving one or both footrests, relative to the supporting calf spine portion.

Adjustment provisions also include the ability to change back-height, upper arm length, forearm-length; thigh-length and calf-length, to accommodate to a significant range of user bodily geometries.

While the preferred embodiment provides both left hand and right hand adjustment capability, which assures substantially total asymmetric accommodation to a user's body geometry requirements, it is contemplated that a wheelchair embodiment incorporating only some of the elements of geometry adjustment in accordance with the present invention can provide significant benefits to the user, such as a wheelchair with one fixed and one adjustable side. Also, in some instances, particularly for custom-built chairs, selected ones of the disclosed adjustabilities may be found to be redundant.

The running gear of the ‘chair’ consists of three pairs of wheels, comprising a pair of larger wheels longitudinally located near the centre of gravity of the chair; with front and back pairs of smaller castoring wheels. The front and back pairs of castoring wheels are independently suspended, being each mounted on a spring-loaded radius arm, which facilitates both the climbing and the descending action of the chair, while enabling the central, driving wheels to maintain driving contact with the supporting surface.

### BRIEF DESCRIPTION OF THE SEVERAL VIEWS OF THE DRAWING

Certain embodiments of the present invention are described by way of illustrating the invention, and without limitation thereto, other than as set forth in the accompanying claims, reference being had to the accompanying drawings, wherein:

FIG. 1 is a side elevational view of the geometrical relationship of wheel-size to curb-height;

FIG. 2 is a side elevation of a castor wheel equipped with a pivotal lifting cam embodiment, positioned adjacent a curb;

FIG. 3 is a side elevation similar to FIG. 2, with the wheel mounting a curb;

FIG. 4 is a view similar to FIG. 3, with the wheel upon the curb, and its structure elements in readjusted mutual relation.

FIG. 5 is frontal perspective view, looking down, of the FIG. 2 embodiment;

FIG. 6 is a front/side elevational perspective of an adjustable wheelchair framework in accordance with the present invention, with its near-side set of running gear;

FIG. 7 is a perspective view of a retractable foot rest for the FIG. 6 embodiment;

FIG. 8 is a front/side elevational perspective of the adjustable frame elements of the FIG. 6 embodiment;

FIG. 9 is a detached perspective view of the FIG. 7 foot support structure; and,

FIG. 10 is a frontal downward perspective of the FIG. 8 elements, in asymmetrically adjusted relation.

### DETAILED DESCRIPTION OF THE INVENTION

The ability of a wheel to climb an obstacle such as a curb is directly affected by the relationship of wheel radius to curb height. When the two are equal, the wheel cannot roll up over the curb by the mere application of horizontal force.

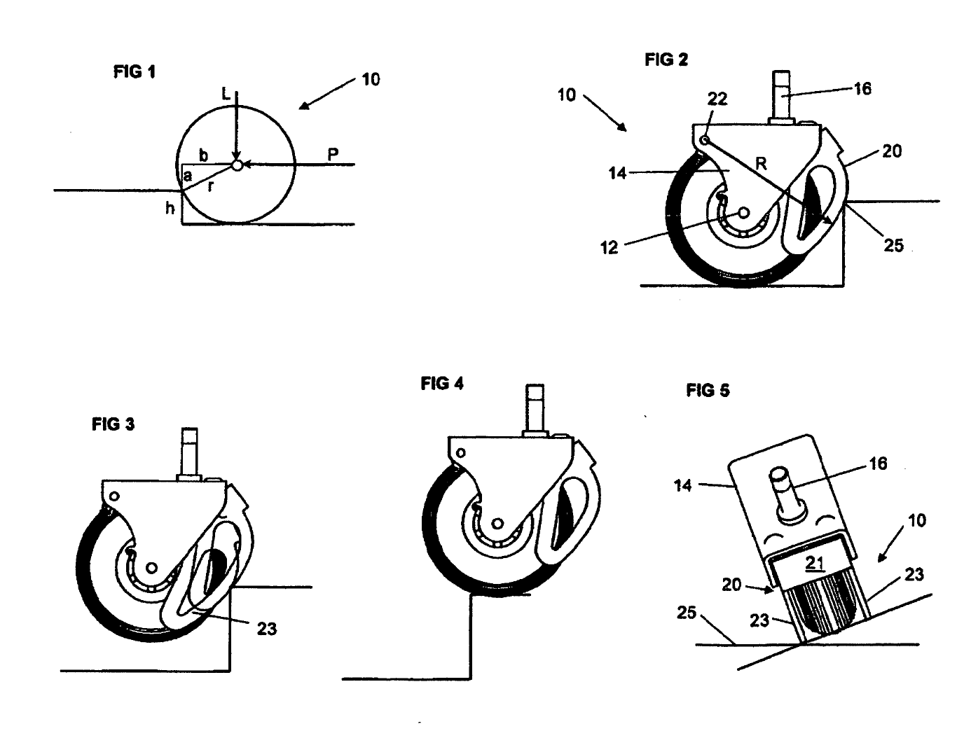

Referring to FIG. 1, for a wheel 10 of radius ‘r’ and bearing a vertical load ‘L’, that is being pushed onto a curb of height ‘h’ by a horizontally applied force ‘P’, where wheel radius ‘r’ exceeds curb height ‘h’ by an amount ‘a’:

Then: P=L×b/a [where ‘b’-squared equals ‘r’-squared minus ‘a’-squared]

As curb height ‘h’ approaches the wheel radius ‘r’, the required force ‘P’ increases significantly.

Referring to FIG. 2, a castored wheel 10 (of a wheelchair, not shown, having two such castoring wheels 10) is mounted on an axle 12 that is secured between a pair of forks 14 attached to a vertical castoring axle 16, for attachment to the wheelchair.

A “virtual wheel” or elevator, 20 in accordance with the present invention, is biased by a retaining spring (not shown) in an upwardly retracted condition between the forks 14. The elevator 20 has a ‘radius of rotation’ R, being pivotally secured at 22 to the forks 14, for downward arcuate displacement relative to the forks 14, upon encountering a curb edge 25.

Referring also to FIGS. 3 and 4, the forward displacement of the attached wheelchair brings the front edge of the elevator 20 into contact with the curb edge 25 (FIG. 2), and further forward motion of the wheelchair causes elevator 20 to pivot about its axis 22, thereby displacing the wheel 10 and its assembly upwardly, and raising the front end of the wheelchair such that the wheel 10 can then ‘climb’ upon the curb.

This climbing motion by the wheel 10 raises the elevator 20 clear of the curb 25, such that the return spring of the elevator 20 restores it to its upwardly retracted position.

Referring to FIG. 5, it will be seen that elevator 20 has a bridge 21 securely uniting its radius-profiled sidewalls 23. In the event of an elevator 20 making an oblique initial contact with a curb, where only one of the side walls 23 makes that contact, the turning moment about the castor axle 16 produces a reorientation of the wheel 10 about its castoring axis, to bring the second elevator side wall 23 into contact with the curb 25, thus aligning the wheel 10 normal to the face of the curb. This usually precludes the otherwise possible misplacement of the wheel 10 flat against the face of curb 25, (in the absence of elevator 20), due to off-centre contact by the radiused profile of the tire of wheel 10 with the curb 25.

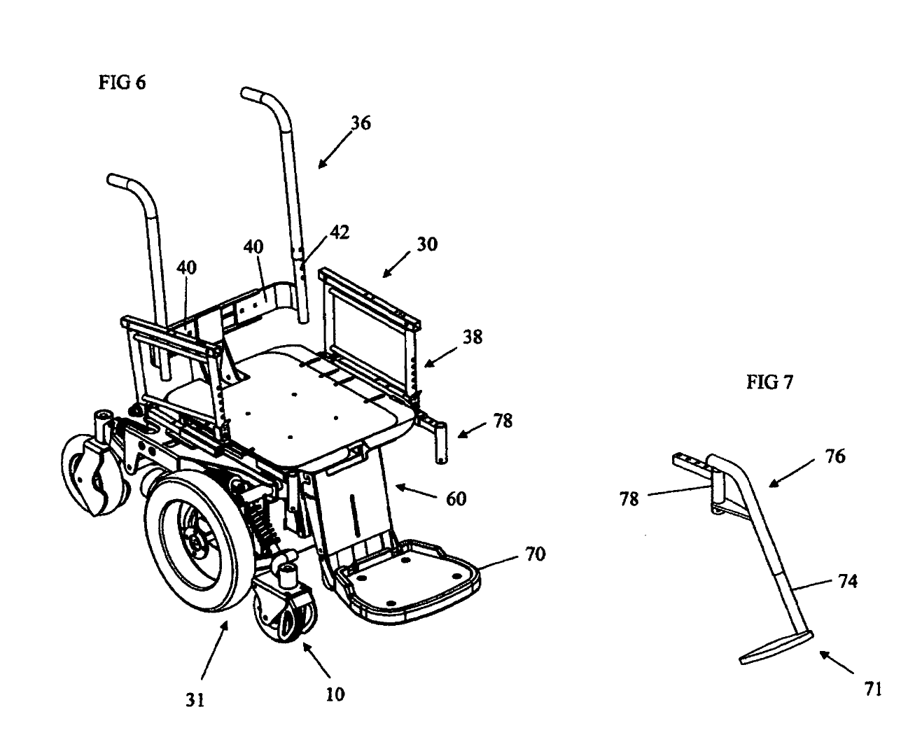

Referring to FIG. 6 through 10, in FIG. 6 the frame portion 30 of a wheelchair, together with the Left-hand side running gear 31 are shown.

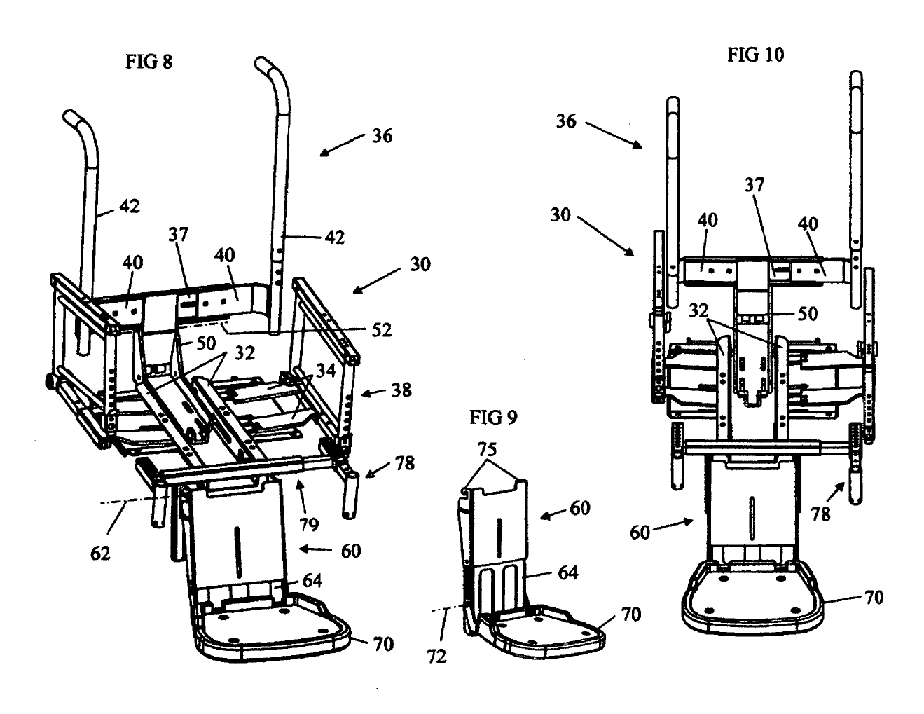

The central spine portions of the frame 30 (best seen in FIGS. 8 and 10) consist of:

a seat base spine portion 32; an angularly adjustable back-bracket spine portion 50;

a calf-bracket spine portion 60, angularly adjustably and removably attached to the front of seat portion 32; and,

a foot-support pan 70 angularly adjustably attached to the bottom of calf bracket spine portion 60.

Each of the three spine portions is selectively slidably extensible, each having two portions in mutual slidable connection.

FIG. 7 shows a pivotally retractable foot pad 71, in its downwardly extended “in-use” position. An extensible support rod 74 is adjustably housed in a triangulated frame 76 that attaches to an extensible bracket 78.

As shown in FIGS. 6 and 8, bracket 78 is slidably mounted at the front of the seat portion 32, by way of a laterally extensible ‘I’-shaped support 79, of hollow, square-section telescoped tubing.

In FIG. 9, the foot support pan 70 is attached to the bottom of calf bracket spine portion 64 by way of a lateral pivotal axis 72, to permit angular adjustment of pan 70.

The calf-bracket spine portion 60 is removably hooked to the front of seat base 32 for way of a laterally extending pivotal axis 62, and has an adjustable downwardly extensible portion 64.

The angularly adjustable foot-support bracket 70 is attached to the bottom of calf bracket spine portion 64 by way of a lateral pivotal axis 72.

In each of FIGS. 6, 8 and 10, the Left hand side and the Right hand side elements of the chair are adjusted to significantly different degrees of extension, to emphasize both the range of adjustment that can be achieved, and the extent by which the chair can be made asymmetrical. These degrees of difference can also be seen in relation to the retraction of the arm rests, the extension of the chair handles, and the inward/outward location of the footrest/footrests 70/71.

The seat base spine portion 32 is of U-section with side flanges, and has laterally projecting outrigger portions 34. The spine portion 32 comprises two pieces in selectively adjustable sliding relation, for adjusting the front-to-back size of spine portion 32.

Adjustable arm-frame canes 38 are slide-mounted to the seat outrigger portions 34, for selective lateral positioning. The arm frame canes 38 are selectively adjustable in height, generally using spring loaded buttons inserted through aligned locating holes for securing purposes

The angularly adjustable back-bracket spine portion 50 is secured at the rear of seat spine portion 32.

The footrest 70 and calf-bracket spine portion 60 are attached to the front of the seat base spine portion 32 by way of a pair of drop-over hooks 75 (see FIG. 9).

The back frame 36 has a pivotal T-bar portion 37, the frame 36 pivoting about lateral pivot 52. The T-bar portion 37 has side arms 40 which receive back “cane” side members 42, with their curved handle ends, in adjustable sliding relation.

Adjustments of the respective body portions is effected by:

for hip extension: rotational adjustment of the backrest portions 40 about the pivotal axis 52;

for knee extension, rotational adjustment of the calf spine portion 60 about the pivotal axis 62;

for ankle extension, rotational adjustment of the foot support bracket 70 about the pivotal axis 72.

1. A wheeled vehicle having front wheels of predetermined size, for use in passage upwardly over an obstacle of predetermined height, said vehicle including elevator means extending in front of said front wheels and positioned to contact said obstacle before said front wheels make contact with said obstacle; wherein forward motion of said vehicle produces reaction between said elevator means and said obstacle, displacing said elevator means downwardly in relation to said wheel, so as to raise the rotational axis of said front wheel above the level of said obstacle, whereby the wheel is enabled to roll up onto the obstacle on the maintenance of said forward motion.

2. The vehicle as set forth in claim 1, said front wheels being rotatably mounted between a pair of forks, said forks being secured to said vehicle by a substantially vertical castor axle about which said wheel is oriented.

3. The vehicle as set forth in claim 1, wherein said elevator means has at least one contact member for contacting said obstacle pivotally attached to said forks at a location positioned above said front wheel rotational axis.

4. The vehicle as set forth in claim 3, said elevator means having a pair of said contact members; a transversely extending bridge member securing said contact members in mutually parallel, load sharing relation.

5. The vehicle as set forth in claim 4, said contact members having a substantially arcuate profile.

6. The vehicle as set forth in claim 3, the radius of rotation of said elevator means from said forks being significantly greater than the radius of said wheel.

7. An adjustable chair structure for supporting the person of a user thereon, having a spine portion comprising at least two parts, at least one of which parts has two portions in mutual selectively slidable relation to enable elongation of that part; and laterally extensible body support portions secured to said spine portion, to provide a range of lateral and longitudinal adjustments to said chair structure, to accommodate a range of variation in the position and body geometry of a user.

8. The chair structure as set forth in claim 7, having three said spine portion parts, comprising a centrally located seat spine portion, a back spine portion secured to a rear end of said seat portion, and a calf spine portion secured to the front end of said seat portion.

9. The chair structure as set forth in claim 8, wherein said three spine portion parts are each longitudinally extensible, and where said spine seat and back portions have said laterally extensible body support portions secured thereto.

10. The chair structure as set forth in claim 7, said laterally extensible body support structures including a pair of arm canes and a pair of back canes.

11. The chair structure as set forth in claim 7, having running gear with three pairs of wheels consisting of a central larger pair of driven wheels located near the centre of gravity of the occupied chair, with front and back pairs of smaller castoring wheels, each castoring wheel being independently suspended, to facilitate both the climbing and the descending movement of the chair, while enabling the central, driving wheels to maintain driving contact with the supporting surface.

12. The chair structure as set forth in claim 11, wherein said front and back pairs of castoring wheels are each individually mounted on a spring-loaded radius arm.
